(19) United States
(12) Patent Application Publication
(10) Pub. No.: US 2023/0260234 A1
(43) Pub. Date: Aug. 17, 2023

(54) INFORMATION PROCESSING DEVICE, INFORMATION PROCESSING METHOD, AND PROGRAM

(71) Applicant: SONY GROUP CORPORATION, TOKYO (JP)

(72) Inventor: ANKIT SHARMA, TOKYO (JP)

(21) Appl. No.: 18/005,049

(22) PCT Filed: Jul. 12, 2021
(86) PCT No.: PCT/JP2021/026158

§ 371 Date: Jan. 10, 2023

(30) Foreign Application Priority Data
Jul. 20, 2020 (JP) 2020-124046

(51) Int. Cl. G06T 19/20; G06T 7/50

(52) U.S. Cl. CPC G06T 19/20; G06T 7/50; G06T 2219/2004; G06T 2207/30201

(57) ABSTRACT

An information processing device (10) includes a model integration unit (13). The model integration unit (13) deforms and incorporates a jaw bone model (JBM) into a face model (FM) of a character on the basis of depth distribution information (22) of soft tissue covering the jaw bone.

### FIELD

The present invention relates to an information processing device, an information processing method, and a program.

### BACKGROUND

A technique of generating a three-dimensional model of a subject from a photograph has been developed. For example, Pinscreen (Non Patent Literature 1), loom.ai (Non Patent Literature 2), Bellus 3D (Non Patent Literature 3), and Avatar SDK (Non Patent Literature 4) provide a technique of generating a simple face model on the basis of a photograph taken by a smartphone. There is a case where the oral cavity is not captured in the photograph. Therefore, only a three-dimensional model of the face (face model) is generated from the photograph. Oral models (models such as teeth and tongue) separately prepared are incorporated into the oral cavity.

### CITATION LIST

### Non Patent Literature

Non Patent Literature 1: [online], Pinscreen, [searched on Jun. 25, 2020], Internet <URL: https://www.pinscreen.com/avatarsdk/>
Non Patent Literature 2: [online], loom.ai, [searched on Jun. 25, 2020], Internet <URL: https://loomai.com/>
Non Patent Literature 3: [online], Bellus 3D, [searched on Jun. 25, 2020], Internet <URL: https://www.bellus3d.com/>
Non Patent Literature 4: [online], Avatar SDK, [searched on Jun. 25, 2020], Internet <URL: https://avatarsdk.com/>
Non Patent Literature 5: Wu, C. and Bradley, D. and Garrido, P. and Zollhofer, M. and Theobalt, C. and Gross, M. and Beeler, T. Model-Based Teeth Reconstruction. ACM Transactions on Graphics (TOG) volume 35 number 6, year 2016
Non Patent Literature 6: Gaspard Zoss, Thabo Beeler, Markus Gross, Derek Bradley. Accurate Markerless Jaw Tracking for Facial Performance Capture. ACM Transactions on Graphics (Proceedings of SIGGRAPH). 2019. (Los Angeles, USA)

### SUMMARY

### Technical Problem

However, in the techniques of Non Patent Literatures 1 to 4, the oral model with a fixed shape and size is incorporated into a face model as it is. Therefore, the oral model may not be in harmony with the face model, and the appearance may be unnatural.

On the other hand, in the fields of movies, games, and the like, it is common for creators to manually dispose oral models. Recently, a technique of generating a high-definition face model and a high-definition oral model has been disclosed from Disney Research (Non Patent Literature 5). However, this method requires an environment in which a plurality of cameras can simultaneously capture images, and the processing time becomes long accordingly. Furthermore, the database of oral models of a plurality of persons acquired in advance is required.

A technique of estimating the movement of jaw bones from a video of a person using machine learning has also been disclosed (Non Patent Literature 6). In this method, the positional relationship between a face model and a jaw bone model is established. Here, the position of the jaw bone and the shape of the face are accurately acquired by sandwiching a special calibration device between the teeth of a performer, attaching markers to the face of the performer, and capturing images from several places. The regression function based on the obtained database is trained to calculate the movement of the jaw from the movement of the face. Similarly to the method of Non Patent Literature 5, the method of Non Patent Literature 6 also requires long processing, pre-training, generation of a database using a special device, and the like.

Therefore, the present disclosure proposes an information processing device, an information processing method, and a program capable of easily generating a three-dimensional model of an oral cavity in harmony with a face model.

### Solution to Problem

According to the present disclosure, an information processing device is provided that comprises a model integration unit that deforms and incorporates a jaw bone model into a face model of a character on a basis of depth distribution information of soft tissue covering a jaw bone. According to the present disclosure, an information processing method in which an information process of the information processing device is executed by a computer, and a program for causing the computer to execute the information process of the information processing device, are provided.

### BRIEF DESCRIPTION OF DRAWINGS

FIG. 1 is a diagram for describing the outline of character model generation processing.

FIG. 2 is a diagram illustrating an example of a face model.

FIG. 3 is a diagram illustrating an example of a jaw bone model.

FIG. 4 is a diagram illustrating an example of the jaw bone model.

FIG. 5 is a diagram illustrating an example of an oral model.

FIG. 6 is a diagram illustrating a state where the oral model is incorporated into the jaw bone model.

FIG. 7 is a diagram illustrating types and depth information of soft tissue feature points.

FIG. 8 is a diagram illustrating a coordinate system for defining the depth information.

FIG. 9 is a diagram for describing a method of defining a depth direction.

FIG. 10 is a diagram for describing the method of defining the depth direction.

FIG. 11 is a schematic diagram of a character generation system.

FIG. 12 is a diagram illustrating processing of incorporating the jaw bone model into a base model.

FIG. 13 is a diagram illustrating the processing of incorporating the jaw bone model into the base model.

FIG. 14 is a diagram illustrating the processing of incorporating the jaw bone model into the base model.

FIG. 15 is a diagram illustrating the processing of incorporating the jaw bone model into the base model.

FIG. 16 is a diagram illustrating the processing of incorporating the jaw bone model into the base model.

FIG. 17 is a diagram illustrating an example of information related to a relative position between the base model and a corrected jaw bone model.

FIG. 18 is a diagram illustrating processing of incorporating the jaw bone model into a non-base model.

FIG. 19 is a diagram illustrating the processing of incorporating the jaw bone model into the non-base model.

FIG. 20 is a diagram illustrating the processing of incorporating the jaw bone model into the non-base model.

FIG. 21 is a diagram illustrating the processing of incorporating the jaw bone model into the non-base model.

FIG. 22 is a diagram illustrating the processing of incorporating the jaw bone model into the non-base model.

FIG. 23 is a diagram illustrating a relationship between a face model and a specific soft tissue feature point.

FIG. 24 is a diagram illustrating a relationship between the face model and the specific soft tissue feature point.

FIG. 25 is a diagram illustrating an influence of selection of the soft tissue feature point on fitting.

FIG. 26 is a diagram illustrating an example in which fitting is not appropriately performed.

FIG. 27 is a diagram illustrating another example in which fitting is not appropriately performed.

FIG. 28 is a diagram illustrating a flow of generating a character model using the base model.

FIG. 29 is a diagram illustrating a flow of generating a character model using the non-base model.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

Note that the description will be given in the following order.

[1. Outline of Character Generation System]

[2. Description of Model]

[2-1. Face Model]

[2-2. Jaw Bone Model]

[2-3. Oral Model]

[3. Description of Soft Tissue Feature Point]

[4. Configuration of Character Generation System]

[5. User Interface]

[5-1. Incorporation of Jaw Bone Model into Base Model]

[5-2. Incorporation of Jaw Bone Model into Non-Base Model]

[5-3. Soft Tissue Feature Point Used for Fitting]

[5-4. Modification of Fitting]

[6. Information Processing Method]

[6-1. Flow of Generating Character Model Using Base Model]

[6-2. Generation Flow of Character Model Using Non-Base Model]

[7. Effects]

### 1. Outline of Character Generation Processing

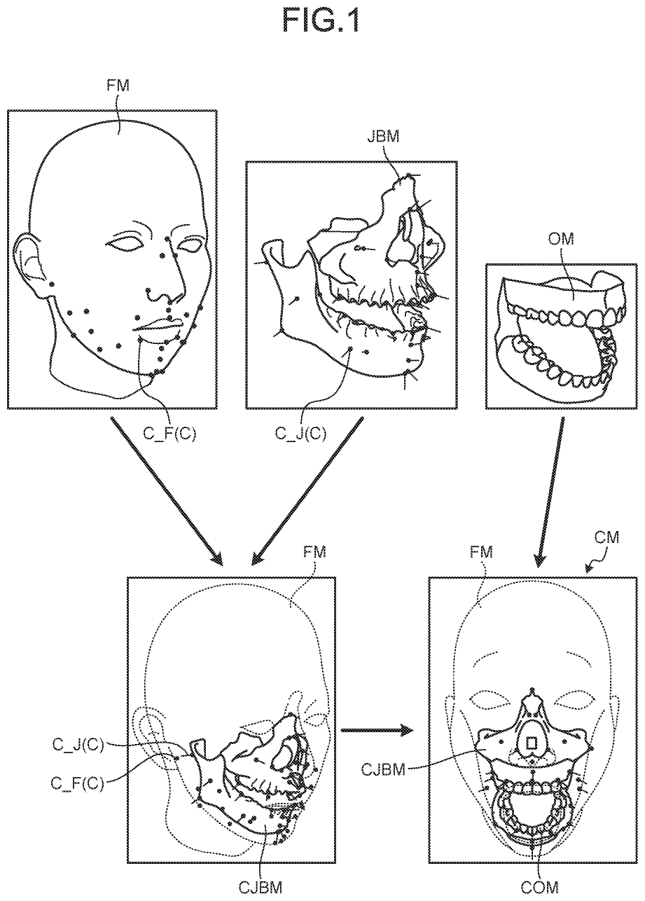

FIG. 1 is a diagram for describing the outline of processing of generating a character model CM (three-dimensional model of a character).

The character model CM is generated by incorporating a jaw bone model JBM and an oral model OM into a face model FM. The face model FM, the jaw bone model JBM, and the oral model OM are created by general CG software. The face model FM, the jaw bone model JBM, and the oral model OM are generated as polygon models. The polygon model includes a polygon mesh including a plurality of vertices, and a plurality of sides and a plurality of surfaces obtained by connecting adjacent vertices.

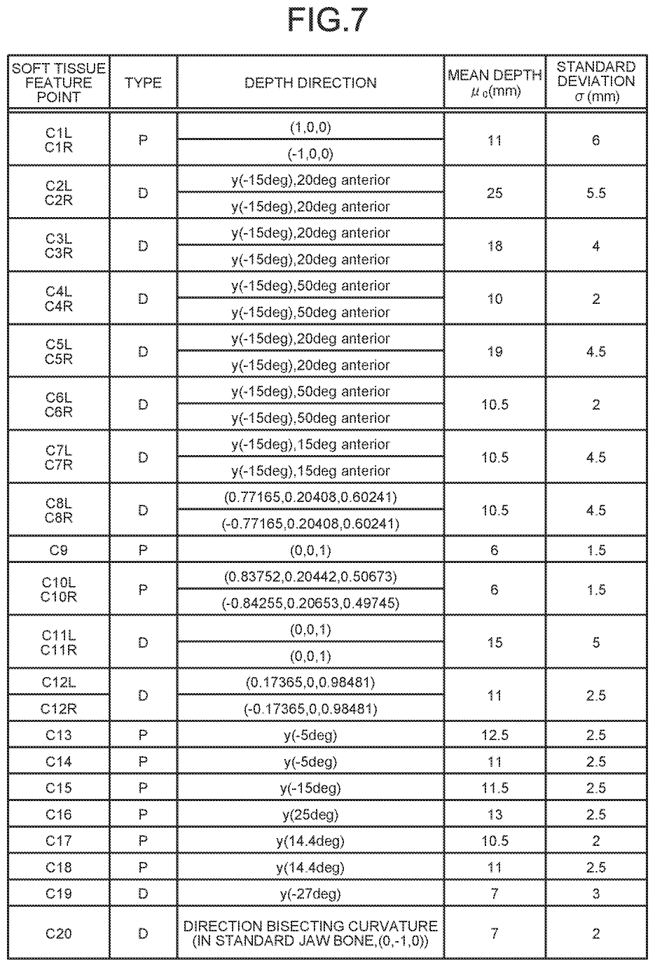

The jaw bone model JBM and the oral model OM are generic models with the standard shape and size. The face model FM is an individual model generated for each character. For this reason, the generic jaw bone model JBM is deformed on the basis of depth distribution information 22 (see FIG. 7) of soft tissue covering the jaw bone and is incorporated into the face model FM. The oral model OM is deformed and is incorporated into a deformed jaw bone model JBM (corrected jaw bone model CJBM). As a result, the three-dimensional model of the oral cavity is generated at a natural looking position.

### 2. Description of Model

[2-1. Face Model]

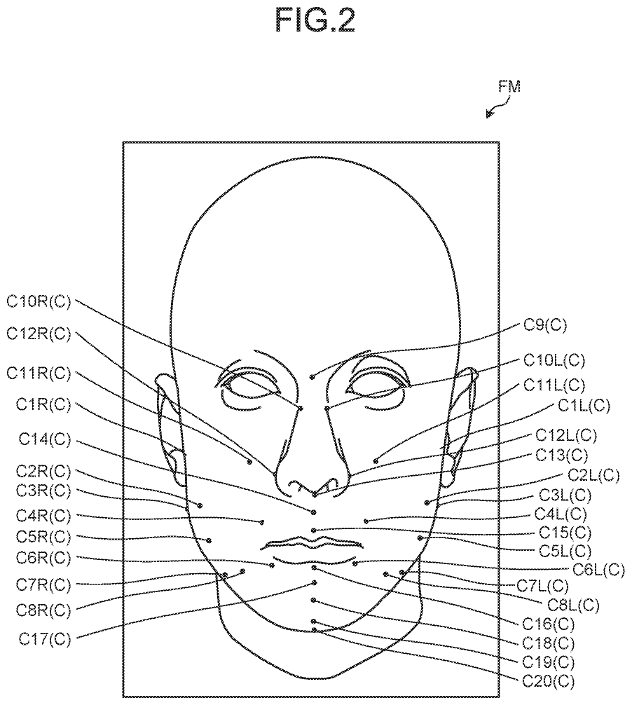

FIG. 2 is a diagram illustrating an example of the face model FM.

The face model FM is a three-dimensional model of the face of a character. The face model FM is generated using, for example, a photograph of the face of a specific person. The photograph of the face is taken using, for example, a camera capable of acquiring depth information of a subject, such as Kinect (registered trademark).

The face is composed of soft tissue. The soft tissue means supporting tissue other than the skeleton, such as muscles and skin. A plurality of soft tissue feature points C are set in the soft tissue covering the jaw bone. Information related to a depth and a depth direction of the soft tissue is set in the soft tissue feature point C.

The soft tissue feature point C is specified by a set of feature points (jaw bone feature point C_J and facial feature point C_F) facing each other in the depth direction of the soft tissue feature point C. The jaw bone feature point C_J is a point obtained by projecting the soft tissue feature point C on the jaw bone along the depth direction. The facial feature point C_F is a point obtained by projecting the soft tissue feature point C on the face along the depth direction. Each of the jaw bone feature point C_J and the facial feature point C_F corresponds one-to-one with the soft tissue feature point C.

Hereinafter, the plurality of soft tissue feature points C may be numbered in order to distinguish the soft tissue feature points from each other. The feature points associated with the same soft tissue feature point C are denoted by the same number. The soft tissue feature points C of the same type arranged at symmetrical positions with respect to the sagittal plane are denoted by the same number, and the soft tissue feature points C are distinguished from each other by reference signs L (left side) and R (right side). For example, in the example of FIG. 2, 20 types of soft tissue feature points C are set on the face.

[2-2. Jaw Bone Model]

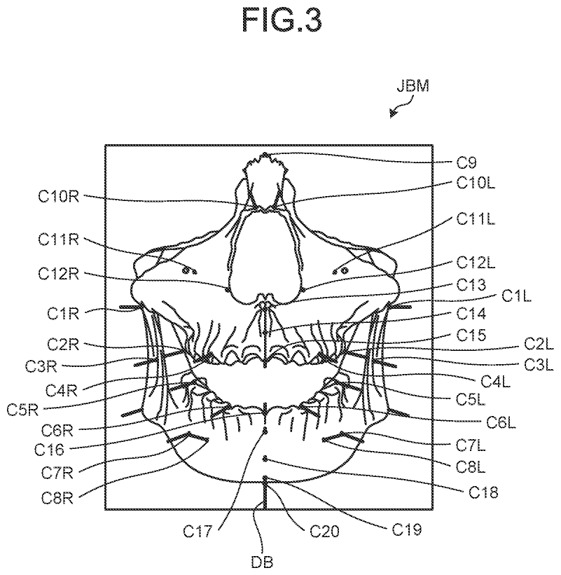

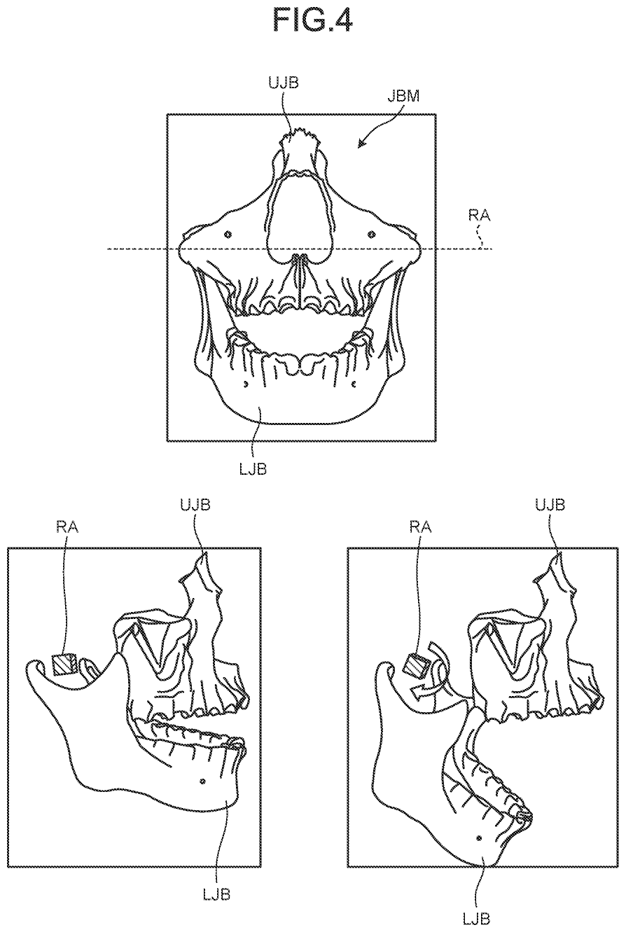

FIGS. 3 and 4 are diagrams illustrating an example of the jaw bone model JBM.

The jaw bone model JBM is a generic three-dimensional model of a jaw bone with standard shape and size. As illustrated in FIG. 3, a plurality of jaw bone feature points C_J are set on the jaw bone model JBM. As illustrated in FIG. 4, the jaw bone model JBM has an upper jaw bone UJB and a lower jaw bone LJB. The lower jaw bone LJB can rotate about a rotation axis (hinge axis) RA. The lower jaw bone LJB can move relative to the upper jaw bone UJB in a direction parallel to the rotation axis RA.

[2-3. Oral Model]

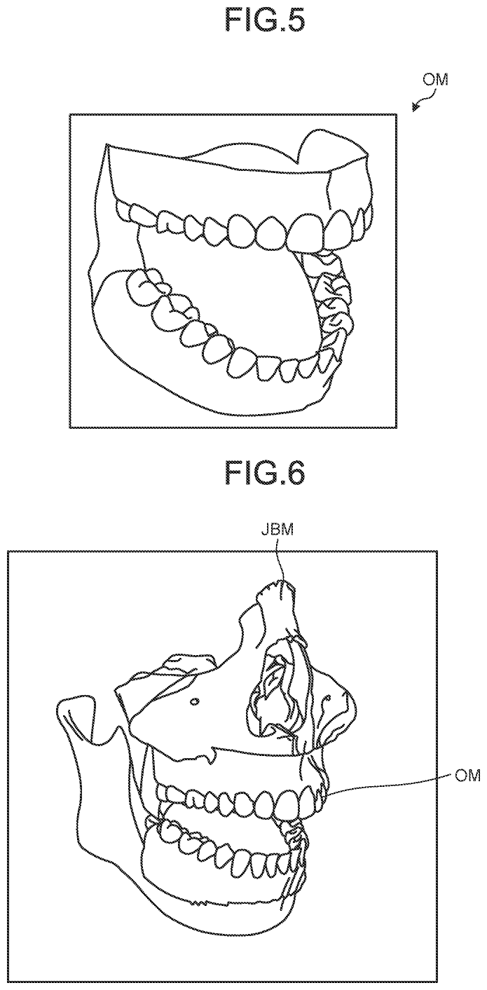

FIG. 5 is a diagram illustrating an example of the oral model OM. FIG. 6 is a diagram illustrating a state where the oral model OM is incorporated into the jaw bone model JBM.

The oral model OM is a generic oral three-dimensional model with a standard oral structure (shapes, sizes, positions, and the like of teeth, gums, tongue, and the like arranged in the oral cavity). The oral model OM can be joined to the jaw bone model JBM by being enlarged or reduced at a predetermined enlargement ratio. In the example of FIG. 6, the oral model OM is presented as a model with a shape (enlargement ratio is one) that matches the jaw bone model JBM. Therefore, the oral model OM can be incorporated into the jaw bone model JBM as it is without deformation.

### 3. Description of Soft Tissue Feature Point

A plurality of soft tissue feature points C are set in the soft tissue covering the jaw bone. Each soft tissue feature point C is defined as follows on the basis of the jaw bone feature point C_J and the facial feature point C_F.

Soft Tissue Feature Point C1 (ar_L/R)

Jaw bone feature point C1_J: a point at the end of the mandible closest to the temporal bone.

Facial feature point C1_F: a point at a position extended in the horizontal direction (direction parallel to the rotation axis RA) from the jaw bone feature point C1_J.

Soft Tissue Feature Point C2 (sM2_L/R)

Jaw bone feature point C2_J: the tip of the maxillary alveolar ridge on the crown of the maxillary second molar.

Facial feature point C2_F: a point at a position extended in a specific direction (see FIG. 7) from the jaw bone feature point C2_J.

Soft Tissue Feature Point C3 (mr_L/R)

Jaw bone feature point C3_J: the center point of the mandibular ramus.

Facial feature point C3_F: a point at a position extended in a specific direction (see FIG. 7) from the jaw bone feature point C3_J.

Soft Tissue Feature Point C4 (sC_L/R)

Jaw bone feature point C4_J: the tip of the maxillary alveolar ridge on the crown of the maxillary canine.

Facial feature point C4_F: a point at a position extended in a specific direction (see FIG. 7) from the jaw bone feature point C4_J.

Soft Tissue Feature Point C5 (iM2_L/R)

Jaw bone feature point C5_J: the tip of the mandibular alveolar ridge under the crown of the mandibular second molar.

Facial feature point C5_F: a point at a position extended in a specific direction (see FIG. 7) from the jaw bone feature point C5_J.

Soft Tissue Feature Point C6 (iC_L/R)

Jaw bone feature point C6_J: the tip of the mandibular alveolar ridge under the crown of the mandibular canine.

Facial feature point C6_F: a point at a position extended in a specific direction (see FIG. 7) from the jaw bone feature point C6_J.

Soft Tissue Feature Point C7 (mmb)

Jaw bone feature point C7_J: the center point between the midline and the lateral edge of the mandible.

Facial feature point C7_F: a point at a position extended in a specific direction (see FIG. 7) from the jaw bone feature point C7_J.

Soft Tissue Feature Point C8 (mentale)

Jaw bone feature point C8_J: mental foramen.

Facial feature point C8_F: a point at a position extended in a specific direction (see FIG. 7) from the jaw bone feature point C8_J.

Soft Tissue Feature Point C9 (nasion)

Jaw bone feature point C9_J: the center point of the frontonasal suture.

Facial feature point C9_F: the deepest point of the depression between the nose and the forehead on the midline of the face.

Soft Tissue Feature Point C10 (nasion_L/R)

Jaw bone feature point C10_J: the lowest point located 5 mm laterally from the midline of the nasal bone.

Facial feature point C10_F: a point located 5 mm laterally from the midline of the nose and 10 mm below the jaw bone feature point C9_J.

Soft Tissue Feature Point C11 (ch_L/R)

Jaw bone feature point C11_J: suborbital foramen.

Facial feature point C11_F: a point at a position extended in a specific direction (see FIG. 7) from the jaw bone feature point C11_J.

Soft Tissue Feature Point C12 (acp_L/R)

Jaw bone feature point C12_J: a point beside the nare.

Facial feature point C12_F: a point at a position extended in a specific direction (see FIG. 7) from the jaw bone feature point C12_J.

Soft Tissue Feature Point C13 (sn)

Jaw bone feature point C13_J: the point of the anterior nasal spine on the midline of the maxilla.

Facial feature point C13_F: the deepest point on the face where the septum is joined to the upper lip.

Soft Tissue Feature Point C14 (mp)

Jaw bone feature point C14_J: a midpoint between the jaw bone feature point C13_J and the jaw bone feature point C15_J on the midline of the maxilla.

Facial feature point C14_F: a midpoint between the facial feature point C13_F and the facial feature point C15_F on the midline of the face.

Soft Tissue Feature Point C15 (ls)

Jaw bone feature point C15_J: the most anterior point of the maxillary alveolar ridge on the midline.

Facial feature point C15_F: a point on the upper vermilion border line on the midline of the upper lip.

Soft Tissue Feature Point C16 (li)

Jaw bone feature point C16_J: the most anterior point of the mandibular alveolar ridge on the midline.

Facial feature point C16_F: a point on the lower vermilion border line on the midline of the lower lip.

Soft Tissue Feature Point C17 (mls)

Jaw bone feature point C17_J: the deepest point of the depression above the mental protuberance on the midline of the mandible.

Facial feature point C17_F: the deepest point of the jaw depression between the facial feature point C16_F and the facial feature point C18_F on the midline of the jaw.

Soft Tissue Feature Point C18 (pg)

Jawbone feature point C18_J: the most anterior point of the mandibular prominence (mental protuberance) on the midline.

Facial feature point C18_F: the most anterior point of the soft tissue prominence of the jaw on the midline.

Soft Tissue Feature Point C19 (gn)

Jaw bone feature point C19_J: a midpoint between the jaw bone feature point C18_J and the jaw bone feature point C20_J on the midline of the mandible.

Facial feature point C19_F: a point at a position extended in a specific direction (see FIG. 7) from the jaw bone feature point C19_J.

Soft Tissue Feature Point C20 (m)

Jaw bone feature point C20_J: the lowest point of the mandibular junction on the midline.

Facial feature point C20_F: a point at a position extended in a specific direction (see FIG. 7) from the jaw bone feature point C19_J.

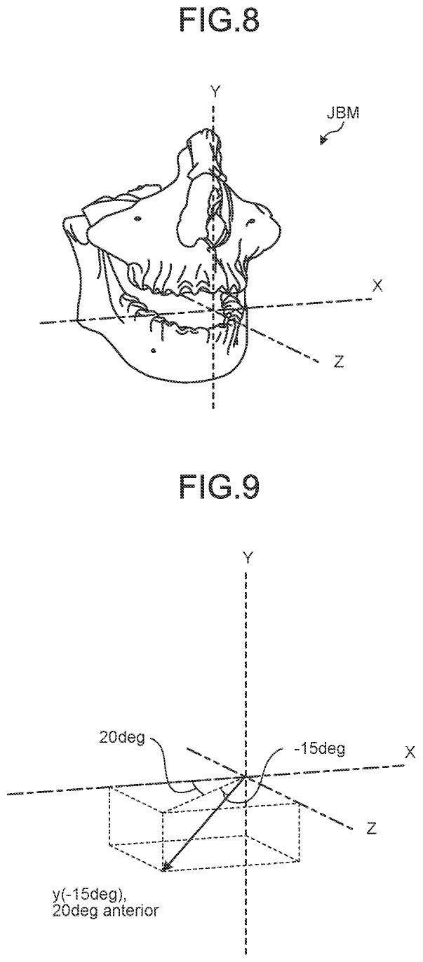

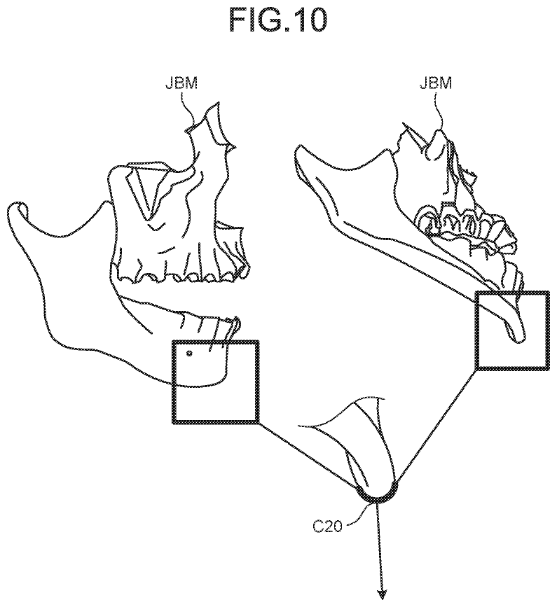

FIG. 7 is a diagram illustrating types and depth information of the soft tissue feature points C. FIG. 8 is a diagram illustrating a coordinate system for defining the depth information. FIGS. 9 and 10 are diagrams for describing a method of defining a depth direction.

As illustrated in FIG. 7, the plurality of soft tissue feature points C are classified into a type P and a type D. The type P is a type in which the facial feature point C_F is defined on the basis of the characteristic structure of the face. The type D is a type in which the facial feature point C_F is defined not by the characteristic structure of the face but by an azimuth (depth direction) from the jaw bone feature point C_J. Note that the jaw bone feature point C_J is defined on the basis of the characteristic structure of the jaw bone in both the type P and the type D.

The depth information includes, for example, information related to a depth direction of soft tissue, a mean depth (standard depth), and a standard deviation of depth. As illustrated in FIG. 8, the depth direction is set on the basis of, for example, an XYZ coordinate system in which an occlusal plane is an XZ plane, a sagittal plane is a YZ plane, and a coronal plane is an XY plane. The direction from the mandible toward the maxilla is the positive direction of the Y axis, and the direction from the occipital region toward the frontal region is the positive direction of the Z axis. The depth direction and standard depth of the soft tissue are indicated by the direction and length of a bar line DB attached to the jaw bone feature point C_J in FIG. 3.

In FIG. 7, “y(angle a)” means a direction obtained by rotating the direction of (−1, 0, 0) by an angle a around the Z axis toward the direction of (0, −1, 0). “Angle b anterior” means a direction obtained by rotating the direction of (−1, 0, 0) by an angle b around the Y axis toward the direction of (0, 0, 1). “y(angle a) angle b anterior” means a direction obtained by rotating the direction of (−1, 0, 0) by an angle a around the Z axis toward the direction of (0, −1, 0) and further rotating the direction of (−1, 0, 0) toward the direction of (0, 0, 1) by an angle b around the Y axis. FIG. 9 illustrates a direction defined by y(−15 deg) 20 deg anterior”.

As illustrated in FIG. 10, the depth direction of the soft tissue feature point C20 is a direction that bisects the curvature of the jaw bone at the jaw bone feature point C20_J (direction perpendicular to the tangent of the jaw bone). In a standard jaw bone (left jaw bone in FIG. 10), the direction is (0, −1, 0).

The position information and the depth information of the soft tissue feature points C1 to C7, C9, and C12 to C20 described above are based on the information described in the following literature. The data in the following literature is generated by calculating the mean and standard deviation of depth data of soft tissue of about 1500 people.

Stephan, C N and Simpson, E K (2008) Facial Soft Tissue Depths in Craniofacial Identification (Part I): An Analytical Review of the Published Adult Data. Journal of Forensic Sciences 53(6): 1257-1272

Many of the soft tissue feature points C described in the above literature are disposed on the sagittal plane (YZ plane). Therefore, if the jaw bone model JBM is fitted to the face model FM using only these soft tissue feature points C, the amount of rotation and the amount of translational movement of the jaw bone model JBM are not accurately calculated, and the jaw bone model JBM may be disposed at a position inclined to the left and right with respect to the face model FM. Accordingly, the soft tissue feature points C8, C11, and C12 disposed at positions different from the sagittal plane are added by the present inventor.

### 4. Configuration of Character Generation System

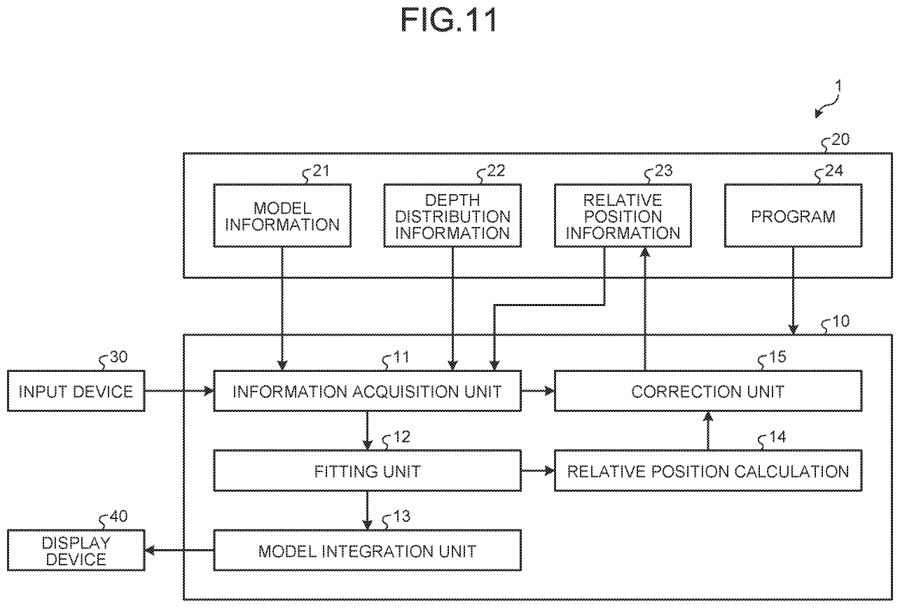

FIG. 11 is a schematic diagram of a character generation system 1.

The character generation system 1 is an information processing system for generating the character model CM. The character generation system 1 includes a processing device 10, a storage device 20, an input device 30, and a display device 40.

The processing device 10 includes an information acquisition unit 11, a fitting unit 12, a model integration unit 13, a relative position calculation unit 14, and a correction unit 15. The processing device 10 is an information processing device that processes various types of information.

The information acquisition unit 11 acquires, for example, model information 21, the depth distribution information 22, and relative position information 23 stored in the storage device 20. The information acquisition unit 11 acquires various types of information input by the user via the input device 30. The input device 30 is a known input device such as a touch panel, a keyboard, and a mouse.

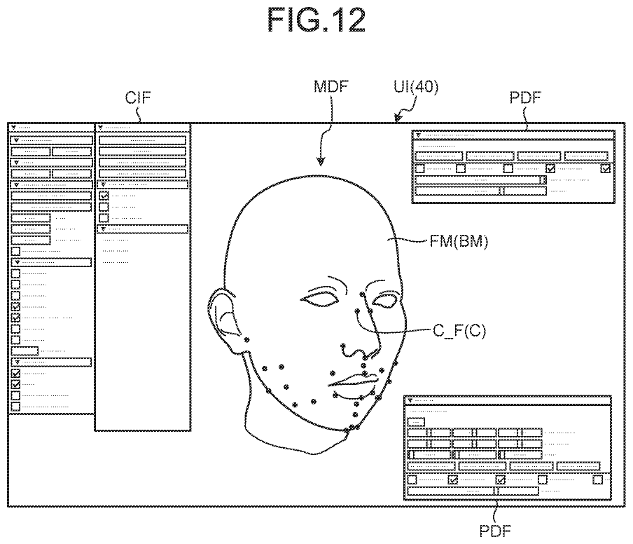

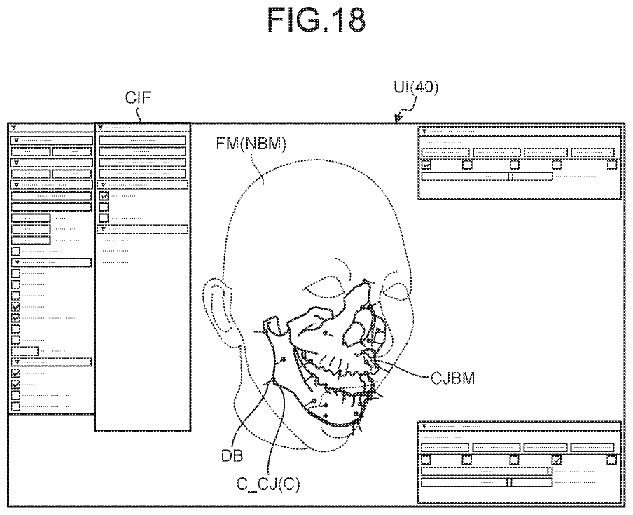

The model information 21 includes coordinate information of polygon meshes constituting the face model FM, the jaw bone model JBM, and the oral model OM. The model information 21 includes information of a plurality of face models FM of the same character. The plurality of face models FM include one base model BM (see FIG. 12) and a plurality of non-base models NBM (see FIG. 18). The base model BM is, for example, a face model FM with no expression. In an expressionless state, all facial muscles are relaxed. The non-base model NBM is a face model FM with a specific expression, and is different from the base model BM. The expression is a change expressed on the face based on emotion or the like. Emotion is a strong feeling caused by a definite cause. In a state other than being expressionless, some of the muscles of the face contract. As the expression of the non-base model NBM, for example, a plurality of expressions with different characteristics such as a smile face, an angry face, and a tearful face are used.

The depth distribution information 22 is information indicating the depth distribution of the soft tissue covering the jaw bone. The depth distribution information 22 includes, for example, position information of a plurality of soft tissue feature points C and depth information of each of the soft tissue feature points C. The position information includes information specifying the position of the soft tissue feature point C (the jaw bone feature point C_J and the facial feature point C_F). The depth information includes, for example, information related to the depth direction of the soft tissue (extending direction of a straight line connecting the jaw bone feature point C_J and the facial feature point CF), the standard depth of the soft tissue, and the standard deviation of the depth of the soft tissue. The depth information is defined as depth information in a face state (expressionless) corresponding to the base model BM.

The relative position information 23 is information related to the relative position between the jaw bone model JBM (corrected jaw bone model CJBM) deformed in accordance with the face model FM and the face model FM. The relative position between the corrected jaw bone model CJBM and the face model FM is defined on the basis of, for example, the relative position between the jaw bone feature point C_J and the facial feature point C_F for each soft tissue feature point C.

The relative position information 23 includes, for example, information related to a positional parameter PO and a deformation parameter S. The positional parameter PO is a parameter indicating a position where the corrected jaw bone model CJBM is incorporated into the face model FM. The positional parameter PO includes, for example, an amount of rotation R of the upper jaw bone UJB and the lower jaw bone LJB about the X axis, the Y axis, and the Z axis, and an amount of translational movement T of the upper jaw bone UJB and the lower jaw bone LJB in the X axis direction, the Y axis direction, and the Z axis direction. The positional parameter PO is set independently for the upper jaw bone UJB and the lower jaw bone LJB. The deformation parameter S is a parameter indicating the amount of deformation of the jaw bone model JBM when the jaw bone model JBM is deformed in accordance with the face model FM. The deformation parameter S indicates, for example, the enlargement ratio of the jaw bone model JBM in the X-axis direction, the Y-axis direction, and the Z-axis direction.

The fitting unit 12 fits the jaw bone model JBM to the face model FM on the basis of the depth distribution information 22. The fitting unit 12 calculates the deformation parameter S and the positional parameter PO of the jaw bone model JBM on the basis of a fitting result. The fitting unit 12 selects a plurality of soft tissue feature points C to be used for fitting from the plurality of soft tissue feature points C1 to C20. The depth information of the plurality of selected soft tissue feature points C is used for fitting. For example, the fitting unit 12 extracts coordinates of a plurality of jaw bone feature points C_J and a plurality of facial feature points C_F corresponding to the plurality of soft tissue feature points C used for fitting from the model information 21 on the basis of the position information of the soft tissue feature points C. The coordinates of the facial feature point C_F are calculated using the coordinates of the corresponding jaw bone feature point C_J, the deformation parameter S, and the positional parameter PO (amount of rotation R, amount of translational movement T).

The fitting unit 12 calculates a probability density function having the depth of the soft tissue as a random variable for each of the plurality of soft tissue feature points C selected from the plurality of soft tissue feature points C1 to C20. The fitting unit 12 calculates the deformation parameter S and the positional parameter PO (amount of rotation R, amount of translational movement T) on the basis of a mathematical model (see the following Formula (1)) that sets a solution that maximizes the sum of the probability density functions of all the selected soft tissue feature points C as an optimal solution.

$${arg max}_{S . R . T} {\sum }_{i} \frac{1}{\sqrt{2 {πσ}_{i}^{2}}} {e}^{- {( \frac{dist ( {J}_{i} , {F}_{i} ) - {μ}_{i}}{{σ}_{i}} )}^{2}} \qquad ( 1 )$$

In Formula (1), “i” denotes the number of the soft tissue feature point C. “σᵢ” denotes the standard deviation of the depth of the soft tissue at a soft tissue feature point Ci. “μᵢ” denotes the mean depth (standard depth) of the soft tissue at the soft tissue feature point Ci. “Jᵢ” denotes the coordinates of the jaw bone feature point Ci_J corresponding to the soft tissue feature point Ci. “Fᵢ” denotes the coordinates of the facial feature point Ci_F corresponding to the soft tissue feature point Ci. “dist (Jᵢ, Fᵢ)” denotes the relative distance (depth) between the jaw bone feature point Ci_J and the facial feature point Ci_F.

The soft tissue feature point C used for fitting is different between the case of performing fitting on the base model BM and the case of performing fitting on the non-base model BM.

For example, in a case where fitting is performed on the base model BM, all of the plurality of soft tissue feature points C1 to C20 is used for fitting. The fitting unit 12 fits the jaw bone model JBM to the base model BM on the basis of the depth information of all the soft tissue feature points C1 to C20. The fitting unit 12 calculates the deformation parameter S and the positional parameter PO of the jaw bone model JBM on the basis of the fitting result. As a result, the deformation parameter S of the jaw bone model JBM shared by all the face models FM of the same character is determined.

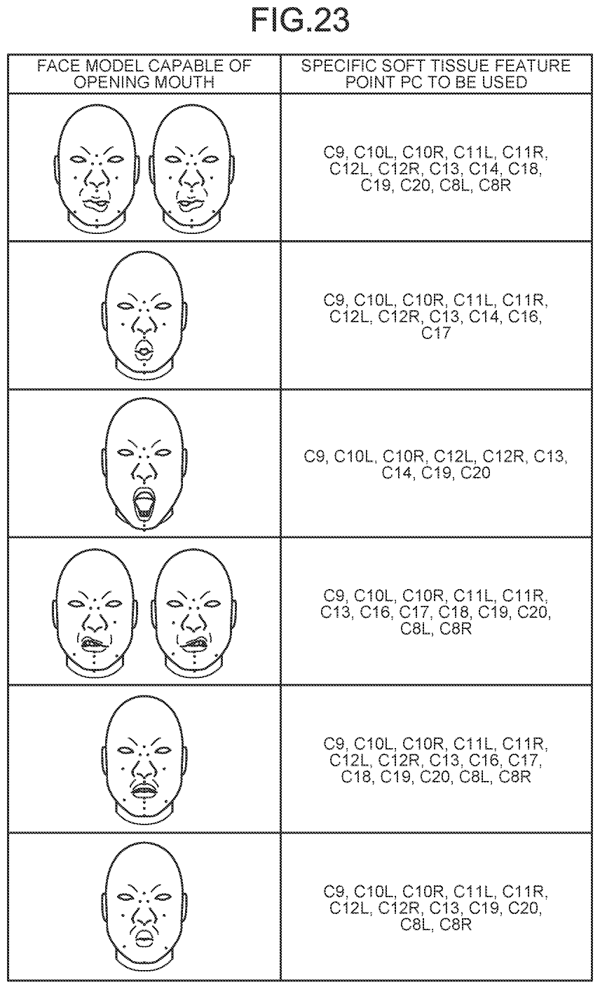

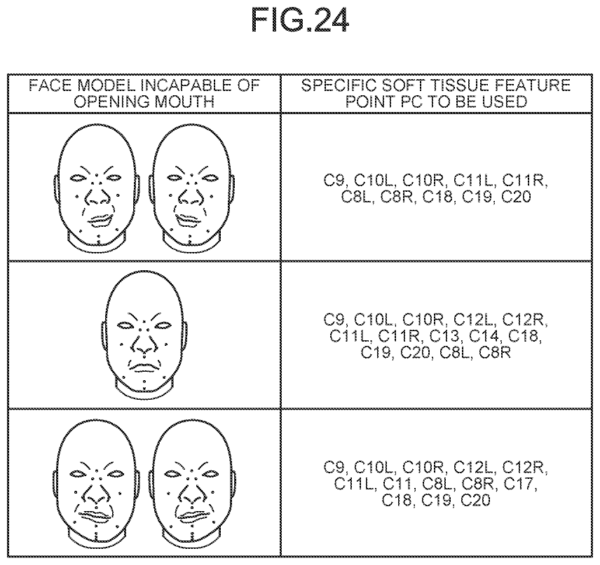

In a case where fitting is performed on another face model FM (non-base model NBM), among the plurality of soft tissue feature points C1 to C20, a plurality of specific soft tissue feature points PC (see FIGS. 23 and 24) in which the depth information does not change due to the change in face shape from the face model FM (base model BM) to another face model (non-base model NBM) are used for fitting. The fitting unit 12 fits the jaw bone model JBM to another face model FM on the basis of the depth information of all the selected specific soft tissue feature points PC while maintaining the deformation parameter S. The fitting unit 12 calculates the positional parameter PO for incorporating the corrected jaw bone model CJBM into another face model FM on the basis of the fitting result.

For example, the fitting unit 12 calculates a probability density function having the depth of the soft tissue as a random variable for each of the plurality of specific soft tissue feature points PC selected in accordance with the expression of the face model FM to be fitted among the plurality of soft tissue feature points C1 to C20. The fitting unit 12 calculates the positional parameter PO on the basis of the mathematical model (the above Formula (1)) that sets a solution that maximizes the sum of the probability density functions of all the selected specific soft tissue feature points PC as an optimal solution.

The positional parameter PO includes, for example, a first positional parameter P1 and a second positional parameter P2. The first positional parameter P1 indicates the relative position between the upper jaw bone UJB and the face model FM. The second positional parameter P2 indicates the relative position between the lower jaw bone LJB and the upper jaw bone UJB. First, the fitting unit 12 fits the jaw bone model JBM to the face model FM on the basis of the depth information of the plurality soft tissue feature points C selected from the plurality of soft tissue feature points C1 to C20, and calculates the first positional parameter P1. The plurality of selected soft tissue feature points C include a plurality of specific soft tissue feature points PC set in the soft tissue covering the upper jaw bone UJB. Next, the fitting unit 12 fits the jaw bone model JBM to the face model FM on the basis of the depth information of the plurality of specific soft tissue feature points PC set in the soft tissue covering the lower jaw bone LJB, and calculates the second positional parameter P2.

The model integration unit 13 deforms and incorporates the generic jaw bone model JBM and oral model OM into the face model FM, thereby generating the character model CM.

The model integration unit 13 first deforms and incorporates the generic jaw bone model JBM into the face model FM of the character on the basis of the depth distribution information 22. For example, the model integration unit 13 deforms the jaw bone model JBM on the basis of the deformation parameter obtained from the fitting result. The model integration unit 13 determines a position where the deformed jaw bone model JBM (corrected jaw bone model CJBM) is incorporated into the face model FM on the basis of the positional parameter PO. The model integration unit 13 disposes the corrected jaw bone model CJBM at the determined position and integrates the corrected jaw bone model CJBM with the face model FM.

Next, the model integration unit 13 deforms and incorporates the generic oral model OM into the corrected jaw bone model CJBM. First, the model integration unit 13 calculates an enlargement ratio for incorporating the oral model OM into the jaw bone model JBM on the basis of the coordinate information of the jaw bone model JBM and the oral model OM. The relative position of the teeth and jaws is unchanged. Therefore, the deformation parameter S and the positional parameter PO of the jaw bone model JBM are used as the deformation parameter and the positional parameter of the oral model OM. The model integration unit 13 calculates the deformation parameter of the oral model OM on the basis of the calculated enlargement ratio and the deformation parameter S of the jaw bone model JBM. The model integration unit 13 deforms the oral model OM on the basis of the calculated deformation parameter. The model integration unit 13 incorporates the deformed oral model OM into the corrected jaw bone model CJBM on the basis of the positional parameter PO of the jaw bone model JBM, and integrates the deformed oral model OM with the corrected jaw bone model CJBM.

The model integration unit 13 sequentially outputs the coordinate information and the parameter information of various types of models being integrated to the display device 40. The display device 40 is a known display device such as a liquid crystal display (LCD) or an organic light emitting diode (OLED). The coordinate information output to the display device 40 includes coordinate information of the face model FM, the jaw bone model JBM, and the oral model OM before and after incorporating the jaw bone model JBM and the oral model OM into the face model FM. The parameter information includes information of the deformation parameter and the positional parameter of the jaw bone model JBM and the oral model OM when the jaw bone model JBM and the oral model OM are incorporated into the face model FM. The display device 40 displays images of various types of models being integrated and values of various parameters on the basis of the information output from the model integration unit 13.

The user can input correction information for correcting the relative positions of the face model FM, the corrected jaw bone model CJBM, and the corrected oral model COM on the basis of a preview image displayed on the display device 40. The correction information includes, for example, parameter correction information and depth distribution correction information. The parameter correction information is information for correcting the deformation parameter S and the positional parameter PO of the jaw bone model JBM. The depth distribution correction information is information for correcting the depth distribution information 22. The information acquisition unit 11 acquires the correction information input by the user via the input device 30. In response to acquisition of the depth distribution correction information by the information acquisition unit 11, the fitting unit 12 corrects the depth distribution information 22 on the basis of the depth distribution correction information. The fitting unit 12 performs fitting on the basis of the corrected depth distribution information (corrected depth distribution information).

The relative position calculation unit 14 calculates the relative position of the face model FM, the corrected jaw bone model CJBM, and the corrected oral model COM for each face model FM. For example, the relative position calculation unit 14 calculates, for each soft tissue feature point C, the relative position between the jaw bone feature point C_J (corrected jaw bone feature point C_CJ) on the corrected jaw bone model CJBM and the facial feature point C_F. The relative position calculation unit 14 calculates information related to the relative position between the corrected jaw bone feature point C_CJ and the facial feature point C_F for each soft tissue feature point C as the information indicating the relative position between the face model FM and the corrected jaw bone model CJBM. The relative position calculation unit 14 calculates the information related to the relative position between the corrected jaw bone model CJBM and the corrected oral model COM on the basis of, for example, the positional relationship between the alveolar fossa and the teeth. The relative position calculation unit 14 outputs, as the relative position information 23, information related to the relative position between the face model FM and the corrected jaw bone model CJBM, the relative position between the corrected jaw bone model CJBM and the corrected oral model COM, the deformation parameter S of the jaw bone model JBM, and the deformation parameter of the oral model OM.

The correction unit 15 corrects the information of the deformation parameter S and the positional parameter PO included in the relative position information 23 on the basis of the parameter correction information. The correction unit 15 outputs the relative position information 23 corrected on the basis of the parameter correction information to the storage device 20.

The storage device 20 stores, for example, the program 24 executed by the processing device 10, the model information 21, the depth distribution information 22, and the relative position information 23. The program 24 is a program that causes a computer to execute information processing according to the present embodiment. The processing device 10 performs various types of processing in accordance with the program 24 stored in the storage device 20. The storage device 20 may be used as a work area for temporarily storing processing results of the processing device 10. The storage device 20 includes, for example, any non-transitory storage medium such as a semiconductor storage medium and a magnetic storage medium. The storage device 20 includes, for example, an optical disk, a magneto-optical disk, or a flash memory. The program 24 is stored in, for example, a non-transitory computer-readable storage medium.

The processing device 10 is, for example, a computer including a processor and a memory. The memory of the processing device 10 includes a random access memory (RAM) and a read only memory (ROM). The processing device 10 executes the program 24 to function as the information acquisition unit 11, the fitting unit 12, the model integration unit 13, the relative position calculation unit 14, and the correction unit 15.

### 5. User Interface

Hereinafter, an example of a user interface UI of the character generation system 1 will be described with reference to FIGS. 12 to 29. The user generates the character model CM using the user interface UI displayed on the display device 40.

[5-1. Incorporation of Jaw Bone Model into Base Model]

FIGS. 12 to 16 are diagrams illustrating the processing of incorporating the jaw bone model JBM into the base model BM.

As illustrated in FIG. 12, a command input field CIF, a preview field MDF, and a parameter display field PDF are displayed on the display device 40. Buttons for inputting various commands are displayed in the command input field CIF. In the preview field MDF, various models and preview images during model integration work are displayed.

FIG. 12 illustrates a state where the base model BM is read from the model information 21 and displayed in the preview field MDF. A plurality of facial feature points C_F are displayed in the base model BM. In the parameter display field PDF, values of various parameters during the model integration work are displayed. In the example of FIG. 12, a parameter display field PDF for displaying the parameters of the base model BM and a parameter display field PDF for displaying the parameters of the jaw bone model JBM are displayed separately in the upper part and the lower part on the right side of the display screen.

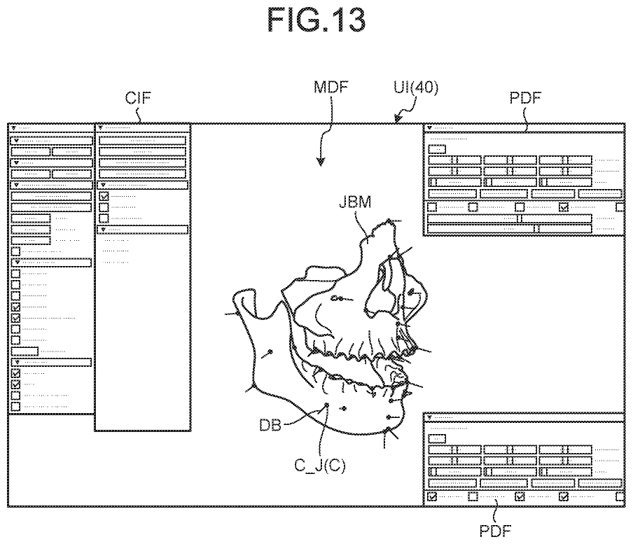

FIG. 13 illustrates a state where the jaw bone model JBM is read from the model information 21 and displayed in the preview field MDF. A plurality of jaw bone feature points C_J are displayed in the jaw bone model JBM. At the jaw bone feature point C_J, the depth information of the soft tissue feature point C corresponding to the jaw bone feature point C_J is displayed by a bar line DB. The orientation and length of the bar line DB represent the depth direction and standard depth of the soft tissue at the soft tissue feature point C.

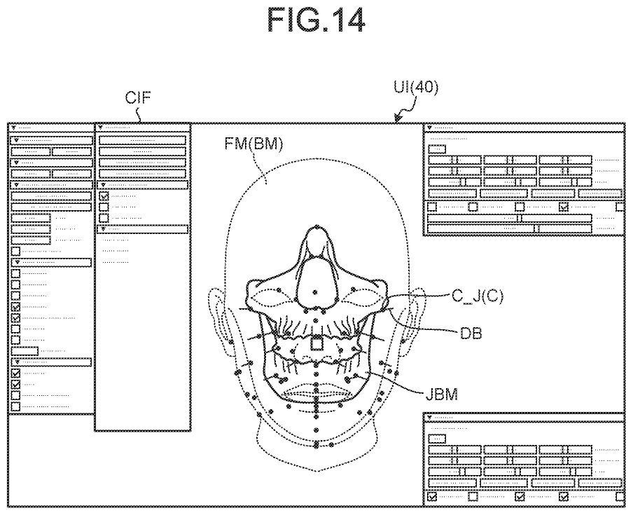

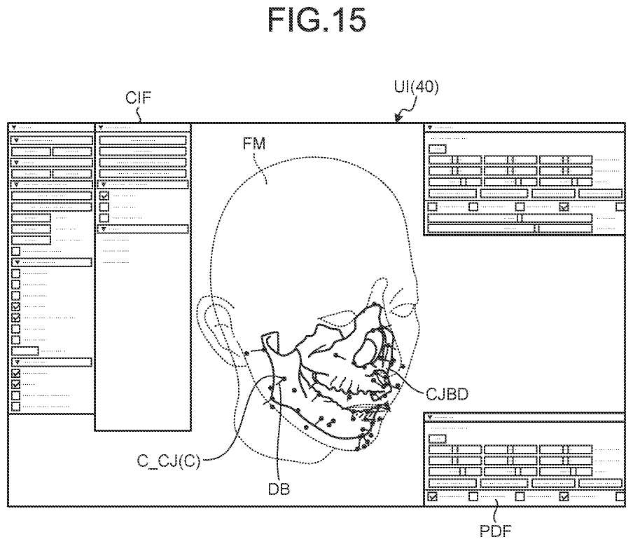

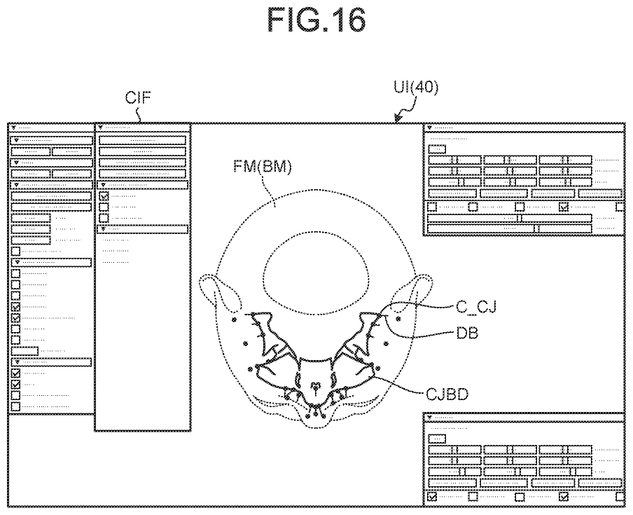

FIG. 14 illustrates a state where the jaw bone model JBM and the base model BM are displayed in the preview field MDF. In this state, when the user presses a first fitting button displayed in the command input field CIF, fitting of the jaw bone model JBM to the base model BM is started. FIG. 15 illustrates a state where the corrected jaw bone model CJBM is incorporated into the base model BM by fitting. As illustrated in FIG. 16, the viewpoint of the preview image can be freely set by the user.

In the preview field MDF, the corrected jaw bone model CJBM obtained by adjusting the shape and position of the jaw bone model JBM in accordance with the base model BM and the plurality of corrected jaw bone feature points C_CJ set on the corrected jaw bone model CJBM are displayed. In the parameter display field PDF for the jaw bone model JBM, the deformation parameter S and the positional parameter PO of the jaw bone model JBM can be displayed. In the parameter display field PDF, the deformation parameter and the first positional parameter P1 of the upper jaw bone UJB and the deformation parameter and the second positional parameter P2 of the lower jaw bone LJB are switched by a switching button and displayed.

At the corrected jaw bone feature point C_CJ, the depth information defined in the depth distribution information 22 is displayed by the bar line DB. The length (standard depth) of the bar line DB does not necessarily match the relative distance between the corrected jaw bone feature point C_CJ and the facial feature point C_F obtained by fitting. In the preview field MDF, the deviation between the relative distance obtained by fitting and the standard depth is color-coded on the basis of the standard deviation 6 and displayed. For example, when the deviation is equal to or less than 6, the bar line DB is displayed in green. When the deviation is larger than 6 and equal to or less than 26, the bar line DB is displayed in yellow. The user can determine whether or not fitting has been appropriately performed in accordance with the number of corrected jaw bone feature points C_CJ to which the green bar line DB is attached.

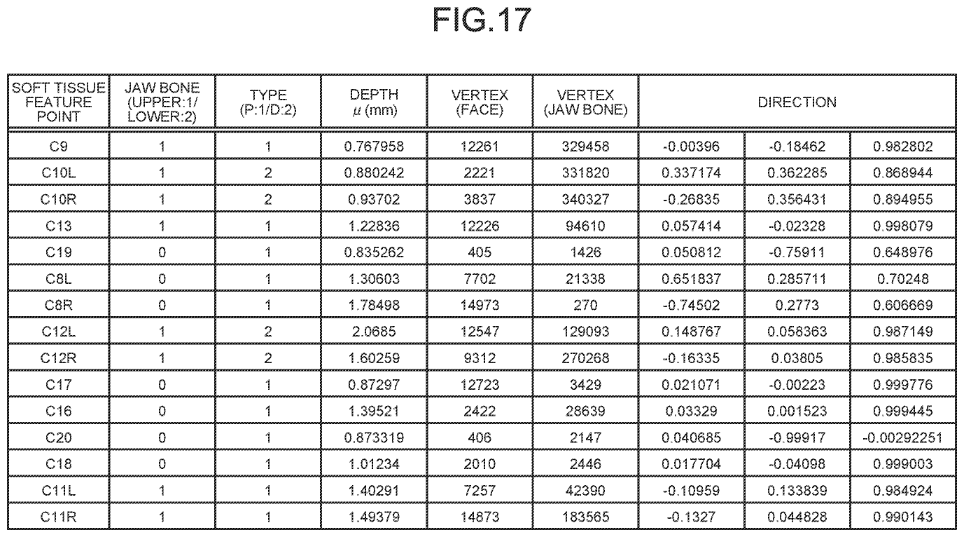

FIG. 17 is a diagram illustrating an example of information related to the relative position between the base model BM and the corrected jaw bone model CJBM calculated by the relative position calculation unit 14.

In FIG. 17, “jaw bone” indicates a portion of the jaw bone covered by the soft tissue in which the soft tissue feature point C is set. “1” indicates the maxilla and “2” indicates the mandible. “Type” indicates the type of the soft tissue feature point C. “1” indicates the type P, and “2” indicates the type D. “Depth” indicates the relative distance between the corrected jaw bone feature point C_CJ and the facial feature point C_F. “Vertex (face)” indicates the number of a vertex closest to the soft tissue feature point C among vertices of the polygon mesh constituting the face model FM. “Vertex (jaw bone)” indicates the number of a vertex closest to the soft tissue feature point C among vertices of the polygon mesh constituting the corrected jaw bone model. “Direction” indicates the depth direction of the soft tissue (extending direction of a straight line connecting the corrected jaw bone feature point C_CJ and the facial feature point C_F).

When the user determines that fitting has been appropriately performed on the basis of the preview image, the user saves the fitting result by a save button provided in the command input field CIF. With this operation, information related to the relative position between the base model BM and the corrected jaw bone model CJBM calculated by the relative position calculation unit 14 is output to the storage device 20 and stored in the storage device 20 as the relative position information 23.

[5-2. Incorporation of Jaw Bone Model into Non-Base Model]

FIGS. 18 to 22 are diagrams illustrating the processing of incorporating the jaw bone model JBM into the non-base model NBM.

FIG. 18 illustrates a state where the non-base model NBM read from the model information 21 and the corrected jaw bone model CJBM generated on the basis of the relative position information 23 related to the base model BM are displayed in the preview field MDF. The corrected jaw bone model CJBM of FIG. 18 is generated on the basis of the deformation parameter S and the positional parameter PO obtained by fitting the jaw bone model JBM to the base model BM. Therefore, the positions of the upper jaw bone UJB and the lower jaw bone LJB are not suitable for the non-base model NBM.

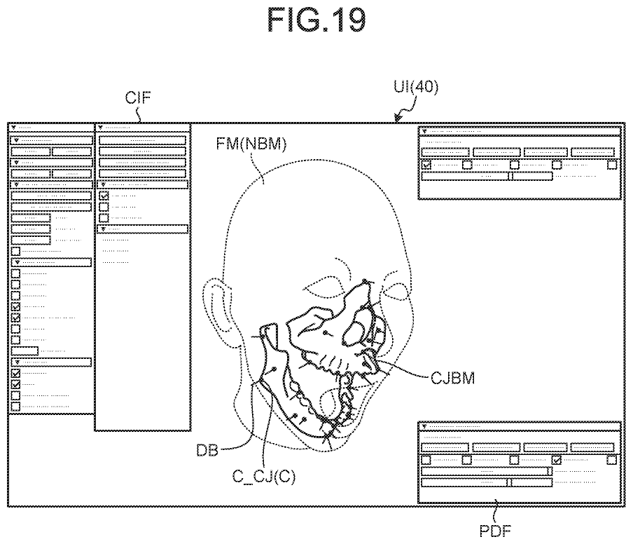

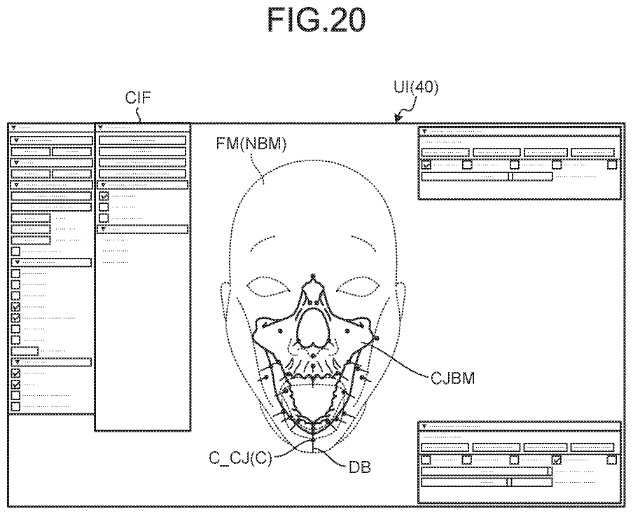

In the state of FIG. 18, when the user presses a second fitting button displayed in the command input field CIF, fitting of the corrected jaw bone model CJBM to the non-base model NBM is started. FIG. 19 illustrates a state where the corrected jaw bone model CJBM is incorporated into the non-base model NBM by fitting. In FIG. 20, a preview image when the viewpoint is arranged in front of the face is displayed.

In the preview field MDF, the corrected jaw bone model CJBM whose position has been adjusted in accordance with the non-base model NBM and the plurality of corrected jaw bone feature points C_CJ set on the corrected jaw bone model CJBM are displayed. In the parameter display field PDF for the jaw bone model JBM, the deformation parameter S and the positional parameter PO of the jaw bone model JBM can be displayed.

At the corrected jaw bone feature point C_CJ, the depth information defined in the depth distribution information 22 is displayed by the bar line DB. In the preview field MDF, the deviation between the standard depth and the relative distance between the corrected jaw bone feature point C_CJ and the facial feature point C_F obtained by fitting is color-coded on the basis of the standard deviation 6 and displayed. The user can determine whether or not fitting has been appropriately performed on the basis of the information of the color-coded bar line DB.

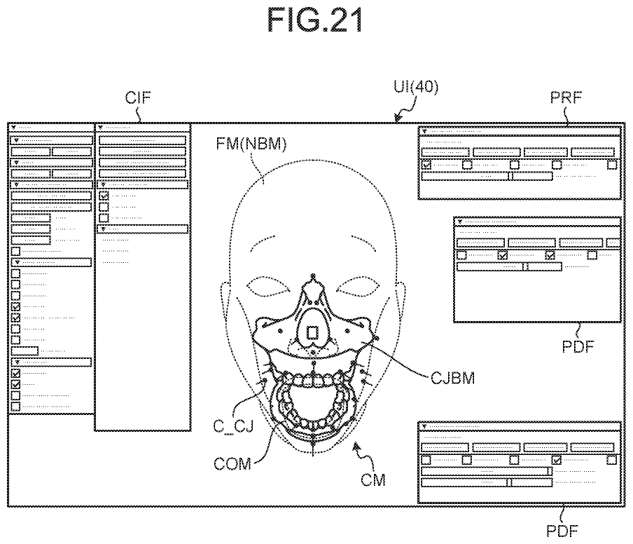

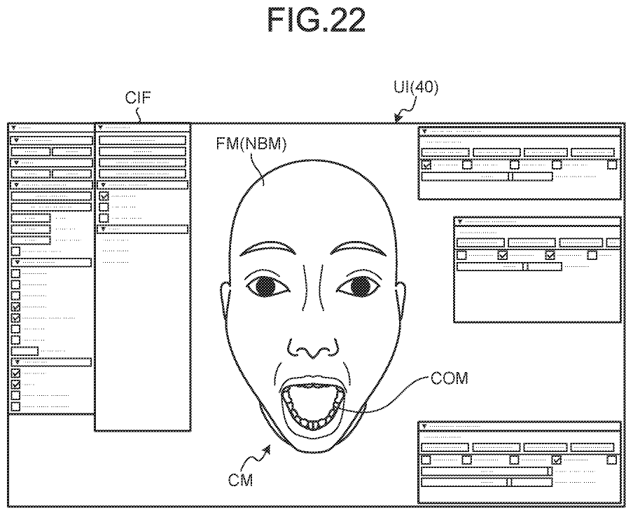

In the state of FIG. 20, the oral model OM is read from the storage device 20, and the relative position information 23 when the jaw bone model JBM is fitted to the non-base model NBM is read as a fitting form. Then, as illustrated in FIG. 21, the oral model OM is deformed and incorporated into the corrected jaw bone model CJBM on the basis of the deformation parameter S and the positional parameter PO of the jaw bone model JBM. As a result, the character model CM is generated. FIG. 22 illustrates a diagram in which the character model CM is converted from a wire frame image to a texture image.

[5-3. Soft Tissue Feature Point Used for Fitting]

The depth distribution information 22 is created on the basis of depth data of an expressionless face (base model BM). When the expression is changed, the depth of the soft tissue at some soft tissue feature points C deviates from the value defined in the depth distribution information 22. When used for fitting on the basis of a wrong depth, an error occurs in the fitting result. Therefore, in a case where fitting is performed on the non-base model NBM, fitting is performed using a plurality of soft tissue feature points C (specific soft tissue feature points PC) in which depth information does not change depending on a change in expression from the base model BM to the non-base model NBM.

FIGS. 23 and 24 are diagrams illustrating a relationship between the face model FM and the specific soft tissue feature point PC used for fitting. FIG. 23 is a diagram illustrating an example of the face model FM capable of opening the mouth, and FIG. 24 is a diagram illustrating an example of the face model FM incapable of opening the mouth.

The type of the specific soft tissue feature point PC is different for each expression. This is because the muscles to be moved vary depending on the facial expression. For example, in a case where the mouth is widely opened, the muscles of the cheeks contract, and the depth of the soft tissue near the cheeks decreases. Therefore, the soft tissue feature point C in the vicinity of the cheeks is not used for fitting. The change in the depth of the soft tissue in accordance with the expression can be predicted in advance. In the model information 21, the correspondence relationship between the face model FM and the specific soft tissue feature point PC used for fitting is defined on the basis of the prediction result. Note that nine types of expressions illustrated in FIGS. 23 and 24 are basic expressions of the character, and other expressions are expressed by a combination of the nine types of basic expressions.

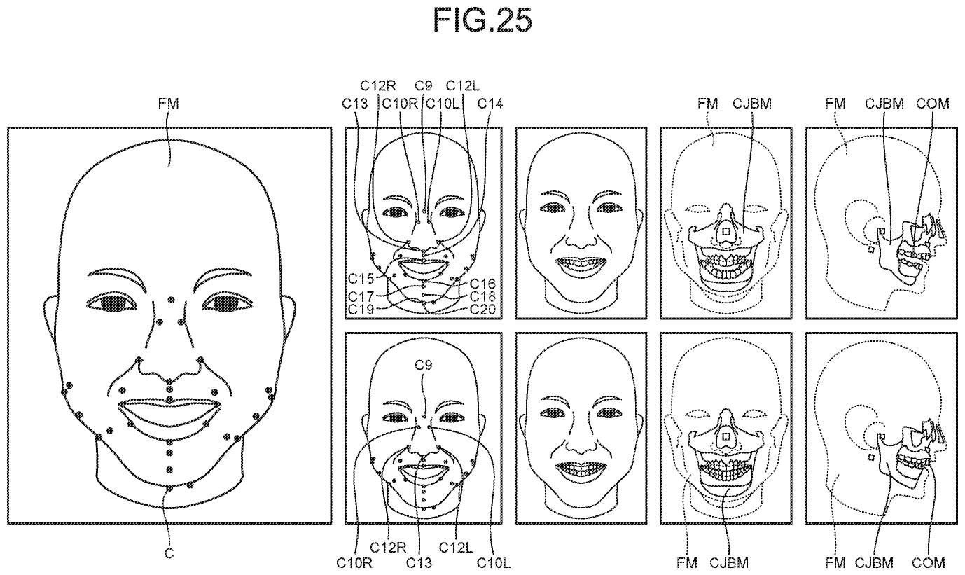

FIG. 25 is a diagram illustrating an influence of selection of the soft tissue feature point C on fitting.

The upper part of FIG. 25 illustrates an example in which the soft tissue feature points C9, C10L, C10R, C12L, C12R, C13, C14, C15, C16, C17, C18, C19, and C20 are used for fitting. The lower part of FIG. 25 illustrates an example in which the soft tissue feature points C9, C10L, C10R, C12L, C12R, and C13 are used for fitting. The upper example and the lower example have different fitting results. In the upper example, the amount of rotation of the lower jaw bone LJB is larger than that in the lower example, and a gap is generated between the upper tooth and the lower tooth when the corrected oral model COM is incorporated. When the soft tissue feature point C used for fitting is incorrectly selected, the generated structure of the oral cavity does not match the expression of the face model FM, and a sense of discomfort is caused.

[5-4. Modification of Fitting]

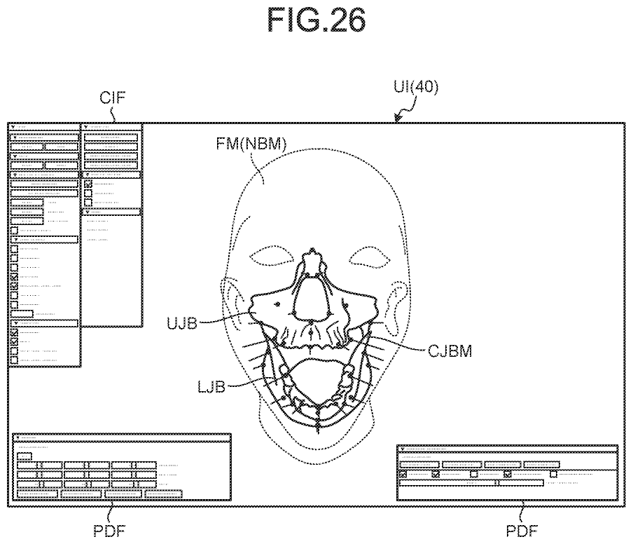

FIG. 26 is a diagram illustrating an example in which fitting is not appropriately performed.

In the example of FIG. 26, the position of the upper jaw bone UJB is shifted leftward from the center CE of the face. The user can input parameter correction information for correcting the deformation parameter and the first positional parameter P1 of the upper jaw bone UJB via the input device 30. For example, the parameter correction information can be input in a mode of overwriting the deformation parameter and the first positional parameter P1 of the upper jaw bone UJB displayed in the parameter display field PDF.

When the parameter correction information is input by the user, the model integration unit 13 modifies the position of the corrected jaw bone model JBM in the preview image on the basis of the deformation parameter and the first positional parameter P1 of the upper jaw bone UJB corrected by the parameter correction information. The correction unit 15 corrects the relative position information 23 on the basis of the deformation parameter and the positional parameter corrected by the parameter correction information. The user checks the position of the corrected jaw bone model CJBM in the preview image. In a case where the corrected jaw bone model CJBM is incorporated at an appropriate position, the user performs a saving operation using the save button in the command input field CIF. With this operation, the relative position information 23 corrected by the correction unit 15 is output to the storage device 20 and stored in the storage device 20.

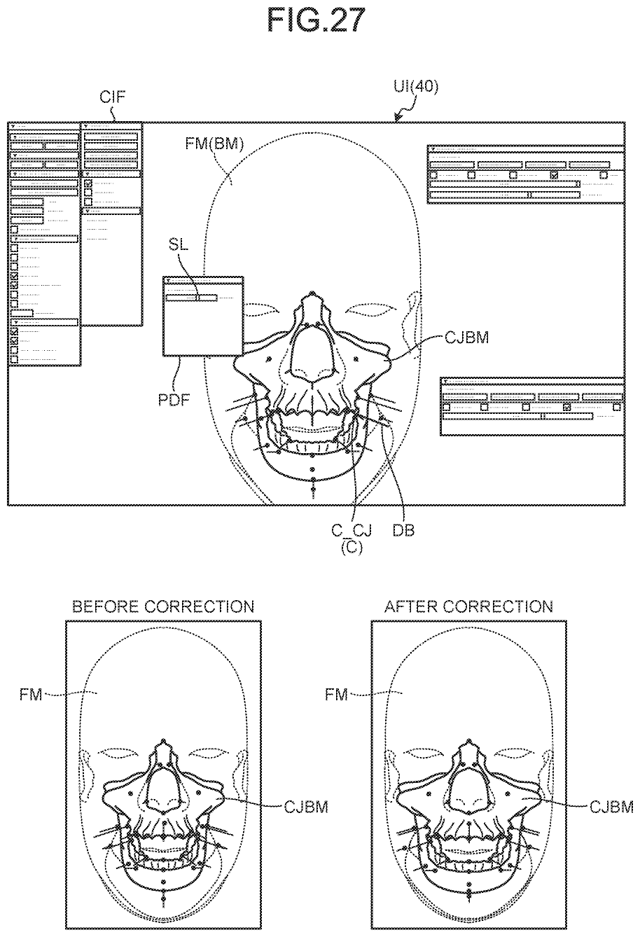

FIG. 27 is a diagram illustrating another example in which fitting is not appropriately performed.

In the upper example of FIG. 27, the width of the corrected jaw bone model CJBM does not match the face model FM. The user specifies the soft tissue feature point C greatly deviated from the standard depth on the basis of the information of the color-coded bar line DB. The user can input, via the input device 30, depth distribution correction information for correcting the depth information of the specified soft tissue feature point C. For example, when the user selects a specific bar line DB with a mouse or the like, the parameter display field PDF for displaying the depth information of the soft tissue feature point C corresponding to the bar line DB appears on the display screen. In the parameter display field PDF, a slider SL for adjusting the value of the standard depth is displayed. The user can input the depth distribution correction information for correcting the standard depth of the soft tissue feature point C by operating the slider SL. For example, in the upper example of FIG. 27, the standard depth of the soft tissue feature point C of the cheek portion can be set small in order to enlarge the jaw bone in the lateral direction.

When the depth distribution correction information is input by the user, the fitting unit 12 corrects the depth distribution information 22 on the basis of the depth distribution correction information. The fitting unit 12 fits the jaw bone model JBM to the face model FM on the basis of the depth distribution information corrected (corrected depth distribution information). The model integration unit 13 deforms and incorporates the jaw bone model JBM into the face model FM on the basis of the deformation parameter S and the positional parameter PO of the jaw bone model JBM obtained by fitting. In the preview image, the user compares the fitting results (the shapes and positions of the corrected jaw bone model CJBM) before and after correcting the depth distribution information 22. In a case where the corrected jaw bone model CJBM is incorporated into the face model FM in an appropriate shape and position by fitting using the corrected depth distribution information, the user performs a saving operation using the save button in the command input field CIF. With this operation, the relative position information 23 calculated on the basis of the corrected depth distribution information is output to the storage device 20 and stored in the storage device 20.

### 6. Information Processing Method

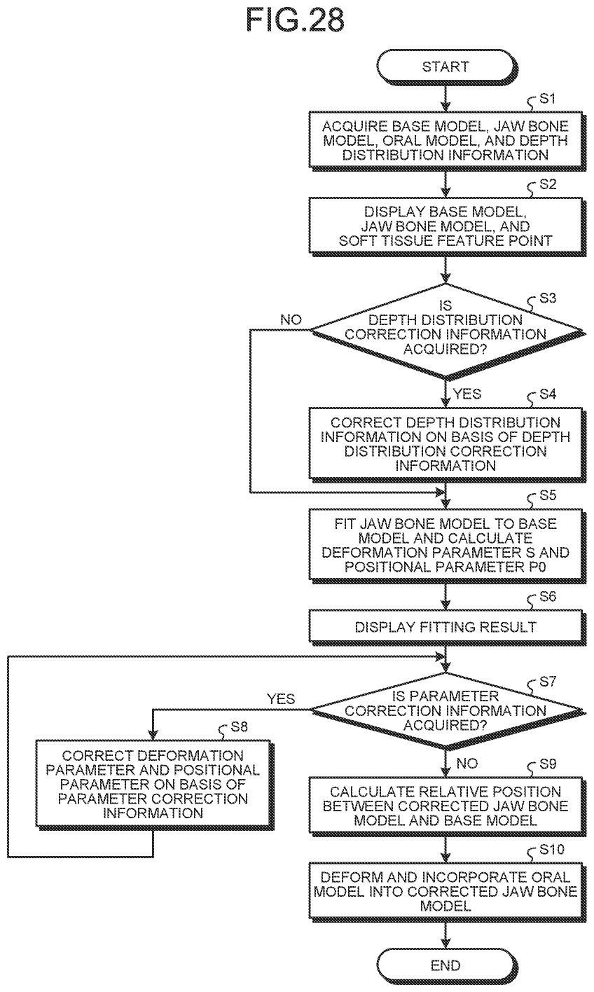

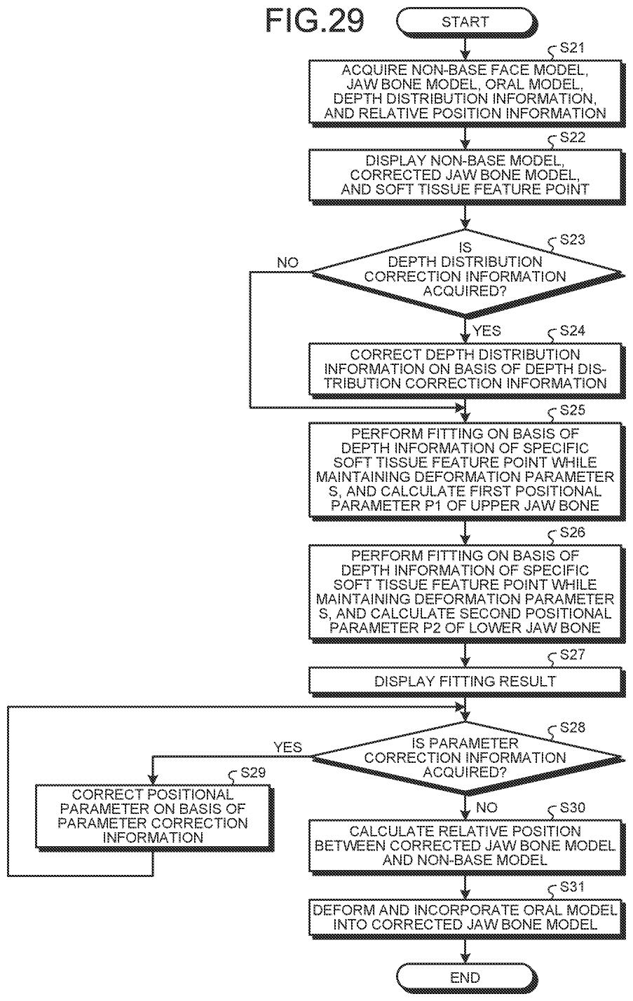

FIGS. 28 and 29 are flowcharts illustrating an example of an information processing method of the processing device 10.

[6-1. Flow of Generating Character Model Using Base Model]

FIG. 28 is a diagram illustrating a flow of generating the character model CM using the base model BM.

In step S1, the information acquisition unit 11 acquires the base model BM, the jaw bone model JBM, the oral model OM, and the depth distribution information 22 from the storage device 20.

In step S2, the model integration unit 13 causes the display device 40 to display the base model BM and the jaw bone model JBM. A plurality of facial feature points C_F corresponding to a plurality of soft tissue feature points C are attached to the base model BM. A plurality of jaw bone feature points C_J corresponding to the plurality of soft tissue feature points C are attached to the jaw bone model JBM.

In step S3, the information acquisition unit 11 determines whether the depth distribution correction information is acquired. If it is determined in step S3 that the depth distribution correction information is acquired (step S3: Yes), the process proceeds to step S4. In step S4, the correction unit 15 corrects the depth distribution information 22 on the basis of the depth distribution correction information. The process then proceeds to Step S5. If it is determined in step S3 that the depth distribution correction information is not acquired (step S3: No), the process proceeds to step S5.

In step S5, the fitting unit 12 fits the jaw bone model JBM to the base model BM on the basis of the depth distribution information 22. The fitting unit 12 calculates the deformation parameter S and the positional parameter PO of the jaw bone model JBM on the basis of a fitting result.

In step S6, the model integration unit 13 causes the display device 40 to display the fitting result. On the display device 40, a state where the corrected jaw bone model CJBM obtained by deforming the jaw bone model JBM with the deformation parameter S is incorporated into the base model BM on the basis of the positional parameter PO is displayed as a preview image.

In step S7, the information acquisition unit 11 determines whether the parameter correction information is acquired. If it is determined in step S7 that the parameter correction information is acquired (step S7: Yes), the process proceeds to step S8. In step S8, the model integration unit 13 corrects the deformation parameter S and the positional parameter PO of the jaw bone model JBM on the basis of the parameter correction information. The model integration unit 13 causes the display device 40 to display the preview image in which the shape and position of the corrected jaw bone model CJBM are corrected on the basis of the corrected deformation parameter S and positional parameter PO. The process then returns to Step S7.

If it is determined in step S7 that the parameter correction information is not acquired (step S7: No), the process proceeds to step S9. In step S9, the relative position calculation unit 14 calculates the relative position between the corrected jaw bone model CJBM and the base model BM. The relative position calculation unit 14 outputs information related to the relative position between the corrected jaw bone model CJBM and the base model BM to the storage device 20 as the relative position information 23.

In step S10, the oral model OM is deformed and incorporated into the corrected jaw bone model CJBM on the basis of the deformation parameter S and the positional parameter PO of the jaw bone model JBM.

Note that, in FIG. 28, before the fitting in step S5, the acquisition determination processing of the depth distribution correction information (step S3) and the correction processing of the depth distribution information (step SS4) is performed. However, these correction processing may be performed after the fitting result is displayed (after step S6).

[6-2. Flow of Generating Character Model Using Non-Base Model]

FIG. 29 is a diagram illustrating a flow of generating the character model CM using the non-base model NBM. The flow of FIG. 29 is performed after the flow of FIG. 28.

In step S21, the information acquisition unit 11 acquires the non-base model NBM, the jaw bone model JBM, the oral model OM, the depth distribution information 22, and the relative position information 23 from the storage device 20.

In step S22, the model integration unit 13 causes the display device 40 to display the non-base model NBM and the corrected jaw bone model CJBM. A plurality of facial feature points C_F corresponding to a plurality of soft tissue feature points C are attached to the non-base model NBM. A plurality of corrected jaw bone feature points C_CJ corresponding to the plurality of soft tissue feature points C are attached to the corrected jaw bone model CJBM.

In step S23, the information acquisition unit 11 determines whether the depth distribution correction information is acquired. If it is determined in step S23 that the depth distribution correction information is acquired (step S23: Yes), the process proceeds to step S24. In step S24, the correction unit 15 corrects the depth distribution information 22 on the basis of the depth distribution correction information. The process then proceeds to Step S25. If it is determined in step S23 that the depth distribution correction information is not acquired (step S23: No), the process proceeds to step S25.

In step S25, the fitting unit 12 extracts the depth information of a plurality of specific soft tissue feature points PC associated with the non-base model NBM from the depth distribution information 22. The fitting unit 12 fits the upper jaw bone UJB of the corrected jaw bone model CJBM to the non-base model NBM on the basis of the depth information of the plurality of specific soft tissue feature points PC. For example, the fitting unit 12 calculates the first positional parameter P1 of the upper jaw bone UJB by applying the depth information of the plurality of specific soft tissue feature points PC selected from the soft tissue feature points C1L, C1R, C2L, C2R, C3L, C3R, C4L, C4R, C9, C10L, C10R, C11L, C11R, C12L, C12R, C13, C14, and C15 to Formula (1). Note that the non-base model NBM is the face model FM of the same character as the base model BM. Therefore, the shape of the corrected jaw bone model CJBM is not changed. As a result, in the fitting, the deformation parameter S of the jaw bone model JBM defined in the relative position information is maintained.

In step S26, the fitting unit 12 fits the lower jaw bone LJB of the corrected jaw bone model CJBM to the non-base model NBM on the basis of the depth information of the plurality of specific soft tissue feature points PC. For example, the fitting unit 12 calculates the second positional parameter P2 of the lower jaw bone LJB by applying the depth information of the plurality of specific soft tissue feature points PC selected from the soft tissue feature points C5L, C5R, C6L, C6R, C7L, C7R, C8L, C8R, C9, C16, C17, C18, C19, and C20 to Formula (1). As a result, in the fitting, the deformation parameter S of the jaw bone model JBM defined in the relative position information is maintained.

In step S27, the model integration unit 13 causes the display device 40 to display the fitting result. On the display device 40, a state where the corrected jaw bone model CJBM is incorporated into the non-base model NBM on the basis of the positional parameter PO (the first positional parameter P1, the second positional parameter P2) is displayed as a preview image.

In step S28, the information acquisition unit 11 determines whether the parameter correction information is acquired. If it is determined in step S28 that the parameter correction information is acquired (step S28: Yes), the process proceeds to step S29. In step S29, the model integration unit 13 corrects the positional parameter PO of the corrected jaw bone model CJBM on the basis of the parameter correction information. The model integration unit 13 causes the display device 40 to display the preview image in which the position of the corrected jaw bone model CJBM is corrected on the basis of the corrected positional parameter PO. The process then returns to Step S28.

If it is determined in step S28 that the parameter correction information is not acquired (step S28: No), the process proceeds to step S30. In step S30, the relative position calculation unit 14 calculates the relative position between the corrected jaw bone model CJBM and the non-base model NBM. Then, in step S31, the model integration unit 13 deforms the oral model OM with the deformation parameter S defined in the relative position information. The model integration unit 13 incorporates the deformed oral model OM (corrected oral model COM) into the corrected jaw bone model CJBM on the basis of the positional parameter PO of the corrected jaw bone model CJBM.

Note that, in FIG. 29, before the fitting in step S25, the acquisition determination processing of the depth distribution correction information (step S23) and the correction processing of the depth distribution information (step S24) is performed. However, these correction processing may be performed after the fitting result is displayed (after step S27).

### 7. Effects

The processing device 10 includes the model integration unit 13. The model integration unit 13 deforms and incorporates the jaw bone model JBM into the face model FM of the character on the basis of the depth distribution information 22 of the soft tissue covering the jaw bone. In the information processing method of the present embodiment, the information processing of the processing device 10 described above is performed by a computer. The program 24 of the present embodiment causes the computer to implement the information processing of the processing device 10 described above.

According to this configuration, the corrected jaw bone model CJBM with an appropriate shape corresponding to the face model FM is generated. By combining the oral model OM with the corrected jaw bone model CJBM, a three-dimensional model with the oral cavity in harmony with the face model FM is easily generated.

The processing device 10 includes the fitting unit 12. The fitting unit 12 fits the jaw bone model JBM to the face model FM on the basis of the depth distribution information 22, and calculates the deformation parameter S and the positional parameter PO. The deformation parameter S indicates the amount of deformation of the jaw bone model JBM. The positional parameter PO indicates a position where the jaw bone model JBM is incorporated into the face model FM.

According to this configuration, the shape and position of the corrected jaw bone model CJBM are appropriately set.

The fitting unit 12 fits the jaw bone model JBM to another face model FM of the same character on the basis of the depth distribution information 22 while maintaining the deformation parameter S. The fitting unit 12 calculates the positional parameter PO for incorporating the jaw bone model JBM into another face model FM by the fitting.

According to this configuration, the positional parameter PO is calculated using the known deformation parameter S. Therefore, the calculation of the positional parameter PO becomes easy. The shape and size of the jaw bone is unchanged for the same character. Accordingly, it is not necessary to calculate the deformation parameter S again. By fixing the deformation parameter S, the amount of calculation is reduced, and the jaw bone model JBM can be quickly disposed at an appropriate position even if the face model FM changes.

The depth distribution information 22 includes position information of a plurality of soft tissue feature points C set in the soft tissue and depth information of each of the soft tissue feature points C. The fitting unit 12 fits the jaw bone model JBM to another face model FM on the basis of the depth information of a plurality of specific soft tissue feature points PC in which the depth information does not change due to the change in the face shape from the face model FM (base model BM) to another face model FM (non-base model NBM) among the plurality of soft tissue feature points C.

The depth information of the soft tissue may change depending on an expression (face model FM). Since fitting is performed on the basis of the input depth distribution information 22, if the depth of the soft tissue feature point C deviates from that defined in the depth distribution information 22, an error occurs in the fitting result. In a case where fitting is performed using only the soft tissue feature point C whose depth information is unchanged, an error due to a change in the depth information does not occur, and an appropriate fitting result is obtained.

The positional parameter PO includes the first positional parameter P1 and the second positional parameter P2. The first positional parameter P1 indicates the relative position between the upper jaw bone UJB of the jaw bone model JBM and another face model FM. The second positional parameter P2 indicates the relative position between the lower jaw bone LJB of the jaw bone model JBM and the upper jaw bone UJB of the jaw bone model JBM. The fitting unit 12 calculates the first positional parameter P1 on the basis of the depth information of the plurality of specific soft tissue feature points PC set in the soft tissue covering the upper jaw bone UJB. The fitting unit 12 calculates the second positional parameter P2 on the basis of the depth information of the plurality of specific soft tissue feature points PC set in the soft tissue covering the lower jaw bone LJB.

According to this configuration, the fitting of the upper jaw bone UJB and the fitting of the lower jaw bone LJB are performed separately. Therefore, the calculation of each fitting becomes easy, and the calculation accuracy is also enhanced.

The depth information includes information related to the depth direction of the soft tissue, the mean depth (standard depth), and the standard deviation of depth. The fitting unit 12 calculates a probability density function having the depth of the soft tissue as a random variable for each of the plurality of specific soft tissue feature points PC selected in accordance with the expression of the face model FM to be fitted among the plurality of soft tissue feature points C. The fitting unit 12 calculates the positional parameter PO on the basis of a mathematical model that sets a solution that maximizes the sum of the probability density functions of all the selected specific soft tissue feature points PC as an optimal solution.

According to this configuration, fitting can be appropriately performed even if the depth of the soft tissue varies between individuals.

The processing device 10 includes the information acquisition unit 11. The information acquisition unit 11 acquires parameter correction information for correcting the deformation parameter S and the positional parameter PO.

According to this configuration, the deformation parameter S and the positional parameter PO can be modified manually when the fitting result is not appropriate.

The information acquisition unit 11 acquires depth distribution correction information for correcting the depth distribution information 22. The fitting unit 12 fits the jaw bone model JBM to the face model FM on the basis of the depth distribution information 22 corrected by the depth distribution correction information.

According to this configuration, even in a case where fitting cannot be performed successfully because the depth of the soft tissue varies between individuals, an appropriate fitting result can be obtained on the basis of the corrected depth distribution information 22.

It should be noted that the effects described in the present specification are merely examples and are not limited, and other effects may be obtained.

Note that the present technology can also have the following configurations.

(1)

An information processing device comprising a model integration unit that deforms and incorporates a jaw bone model into a face model of a character on a basis of depth distribution information of soft tissue covering a jaw bone.

(2)

The information processing device according to (1) further comprising

a fitting unit that fits the jaw bone model to the face model on a basis of the depth distribution information, and that calculates a deformation parameter indicating an amount of deformation of the jaw bone model and a positional parameter indicating a position where the jaw bone model is incorporated into the face model.

(3)

The information processing device according to (2), wherein

the fitting unit fits the jaw bone model to another face model of a same character on a basis of the depth distribution information while maintaining the deformation parameter, and calculates the positional parameter for incorporating the jaw bone model into the another face model.

(4)

The information processing device according to (3), wherein

the depth distribution information includes position information of a plurality of soft tissue feature points set in the soft tissue and depth information of each of the soft tissue feature points, and the fitting unit fits the jaw bone model to the another face model on a basis of the depth information of a plurality of specific soft tissue feature points in which the depth information does not change due to a change in a face shape from the face model to the another face model among the plurality of soft tissue feature points.

(5)

The information processing device according to (4), wherein

the positional parameter includes a first positional parameter indicating a relative position between an upper jaw bone of the jaw bone model and the another face model, and a second positional parameter indicating a relative position between a lower jaw bone and the upper jaw bone of the jaw bone model,

the fitting unit calculates the first positional parameter on a basis of the depth information of a plurality of specific soft tissue feature points set in the soft tissue covering the upper jaw bone, and

the fitting unit calculates the second positional parameter on a basis of the depth information of a plurality of specific soft tissue feature points set in the soft tissue covering the lower jaw bone.

(6)

The information processing device according to (4) or (5), wherein

the depth information includes information related to a depth direction, a mean depth, and a standard deviation of depth of the soft tissue, and

the fitting unit calculates a probability density function having a depth of the soft tissue as a random variable for each of the plurality of specific soft tissue feature points selected in accordance with an expression of a face model to be fitted among the plurality of soft tissue feature points, and calculates the positional parameter on a basis of a mathematical model that sets a solution that maximizes a sum of the probability density functions of all selected specific soft tissue feature points as an optimal solution.

(7)

The information processing device according to any one of (2) to (6), further comprising

an information acquisition unit that acquires parameter correction information for correcting the deformation parameter and the positional parameter.

(8)

The information processing device according to (7), wherein

the information acquisition unit acquires depth distribution correction information for correcting the depth distribution information, and

the fitting unit fits the jaw bone model to the face model on a basis of the depth distribution information corrected by the depth distribution correction information.

(9)

An information processing method performed by a computer, the method comprising deforming and incorporating a jaw bone model into a face model of a character on a basis of depth distribution information of soft tissue covering a jaw bone.

(10)

A program that causes a computer to deform and incorporate a jaw bone model into a face model of a character on a basis of depth distribution information of soft tissue covering a jaw bone.

### REFERENCE SIGNS LIST

10 PROCESSING DEVICE (INFORMATION PROCESSING DEVICE)
11 INFORMATION ACQUISITION UNIT
12 FITTING UNIT
13 MODEL INTEGRATION UNIT
22 DEPTH DISTRIBUTION INFORMATION
24 PROGRAM
C SOFT TISSUE FEATURE POINT
FM FACE MODEL
JBM JAW BONE MODEL
LJB LOWER JAW BONE
PO POSITIONAL PARAMETER
P1 FIRST POSITIONAL PARAMETER
P2 SECOND POSITIONAL PARAMETER
PC SPECIFIC SOFT TISSUE FEATURE POINT
S DEFORMATION PARAMETER
UJB UPPER JAW BONE

1. An information processing device comprising a model integration unit that deforms and incorporates a jaw bone model into a face model of a character on a basis of depth distribution information of soft tissue covering a jaw bone.

2. The information processing device according to claim 1 further comprising
a fitting unit that fits the jaw bone model to the face model on a basis of the depth distribution information, and that calculates a deformation parameter indicating an amount of deformation of the jaw bone model and a positional parameter indicating a position where the jaw bone model is incorporated into the face model.

3. The information processing device according to claim 2, wherein
the fitting unit fits the jaw bone model to another face model of a same character on a basis of the depth distribution information while maintaining the deformation parameter, and calculates the positional parameter for incorporating the jaw bone model into the another face model.

4. The information processing device according to claim 3, wherein
the depth distribution information includes position information of a plurality of soft tissue feature points set in the soft tissue and depth information of each of the soft tissue feature points, and
the fitting unit fits the jaw bone model to the another face model on a basis of the depth information of a plurality of specific soft tissue feature points in which the depth information does not change due to a change in a face shape from the face model to the another face model among the plurality of soft tissue feature points.

5. The information processing device according to claim 4, wherein
the positional parameter includes a first positional parameter indicating a relative position between an upper jaw bone of the jaw bone model and the another face model, and a second positional parameter indicating a relative position between a lower jaw bone and the upper jaw bone of the jaw bone model,
the fitting unit calculates the first positional parameter on a basis of the depth information of a plurality of specific soft tissue feature points set in the soft tissue covering the upper jaw bone, and
the fitting unit calculates the second positional parameter on a basis of the depth information of a plurality of specific soft tissue feature points set in the soft tissue covering the lower jaw bone.

6. The information processing device according to claim 4, wherein
the depth information includes information related to a depth direction, a mean depth, and a standard deviation of depth of the soft tissue, and
the fitting unit calculates a probability density function having a depth of the soft tissue as a random variable for each of the plurality of specific soft tissue feature points selected in accordance with an expression of a face model to be fitted among the plurality of soft tissue feature points, and calculates the positional parameter on a basis of a mathematical model that sets a solution that maximizes a sum of the probability density functions of all selected specific soft tissue feature points as an optimal solution.

7. The information processing device according to claim 2, further comprising
an information acquisition unit that acquires parameter correction information for correcting the deformation parameter and the positional parameter.

8. The information processing device according to claim 7, wherein
the information acquisition unit acquires depth distribution correction information for correcting the depth distribution information, and
the fitting unit fits the jaw bone model to the face model on a basis of the depth distribution information corrected by the depth distribution correction information.

9. An information processing method performed by a computer, the method comprising deforming and incorporating a jaw bone model into a face model of a character on a basis of depth distribution information of soft tissue covering a jaw bone.

10. A program that causes a computer to deform and incorporate a jaw bone model into a face model of a character on a basis of depth distribution information of soft tissue covering a jaw bone.
